(19) United States
(12) Patent Application Publication
(10) Pub. No.: US 2012/0146448 A1
(43) Pub. Date: Jun. 14, 2012

(54) Modular Rotor For Synchronous Reluctance Machine

(76) Inventors: Reza Rajabi Moghaddam, Vasteras (SE); Yujing Liu, Vasteras (SE); Cedric Monnay, Goteborg (SE); Pierluigi Tenca, Vasteras (SE)

(21) Appl. No.: 13/396,244

(22) Filed: Feb. 14, 2012

Related U.S. Application Data
(63) Continuation of application No. PCT/EP2009/060553, filed on Aug. 14, 2009.

(51) Int. Cl. H02K 1/30

(52) U.S. Cl. 310/216.075; 310/216.114

(57) ABSTRACT

A rotor for a synchronous reluctance machine includes a plurality of rotor modules disposed in an axial sequence along a common axis. Each rotor module includes a plurality of poles disposed in adjacent sectors about the common axis, each pole including a plurality of magnetic segments spaced apart from one another in radial direction, a support plate, provided on an axial side of the plurality of poles, and fastening means for fastening the plurality of poles to the support plate. The fastening means, preferably a plurality of axially arranged bolts or an adhesive, bonds the plurality of poles to the support plate.

### CROSS-REFERENCE TO RELATED APPLICATIONS

The present application is a continuation of pending International patent application PCT/EP2009/060553 filed on Aug. 14, 2009 which designates the United States and the content of which is incorporated herein by reference.

### FIELD OF THE INVENTION

The present invention generally relates to rotors for synchronous reluctance machines.

### BACKGROUND OF THE INVENTION

GB 2 378 323 discloses a rotor for a synchronous reluctance machine comprising magnetic core steel laminates with a shaft hole and a plurality of flux barrier groups formed centered around the shaft hole, non-magnetic securing elements passing through the end plates and the laminate stack through the flux barrier groups. Stacking detents may be formed on each laminate around the shaft hole or between the flux barrier groups.

U.S. Pat. No. 7,489,062 discloses a synchronous reluctance machine that has a rotor with laminates stacked in axial direction to form boat shaped segments. A plurality of selected boat shaped segments form a selected number of rotor poles about the rotor shaft, and a plurality of support bars disposed intermittently between the boat shaped segments keep the laminates in place in radial direction.

### SUMMARY OF THE INVENTION

For both rotor structures described above mechanical weakness may limit the size or robustness of the synchronous reluctance machine. In particular, for large synchronous reluctance machines in the megawatt region the above limitations may be important.

Further, the designs of the prior art rotors are not optimum for enabling simple manufacturing techniques to be used.

Accordingly, it is an object of the present invention to provide a rotor for a synchronous reluctance machine and a method of manufacturing a rotor for a synchronous reluctance machine, which address the above issues.

It is in particular an object of the invention to provide such a rotor, which is mechanically strong and robust while still high electric performance is maintained. Simultaneously, the manufacturing method should be simple and flexible.

It is a further object of the invention to provide such an arrangement and such a method, which are fast, precise, accurate, reliable, and of low cost.

These objects among others are, according to the present invention, attained by rotors and a manufacturing method.

According to one aspect of the invention a rotor for a synchronous reluctance machine is provided. The rotor comprises a plurality of rotor modules disposed in an axial sequence along a common axis. Each rotor module comprises: a plurality of poles disposed in adjacent sectors about the common axis, each pole comprising a plurality of magnetic segments spaced apart from one another in radial direction; a support plate provided on at least one axial side of the plurality of poles; and a fastening means for fastening the plurality of poles to the support plate. The fastening means bonds the plurality of poles to the support plate.

The bond between the poles and the support plate keeps the poles in place when a centrifugal force acts on the poles radial outwards in a rotating rotor. In practice, the bonding may be implemented in many different ways such as via adhesives, welding or fasteners. The bonding may also be implemented by casting or molding the spaces between the magnetic segments with electrically non-conducting and non-magnetic filler such as an epoxy, glass fiber or carbon fiber. By ensuring a sufficient bonding strength to firmly fasten the poles to the support plate, a manageable and robust rotor module is obtained. The resulting rotor is robust and can be designed for different power ratings simply by selecting an appropriate number of rotor modules.

In one embodiment the fastening means bonds the axial surface of the plurality of poles to the support plate. It is very advantageous to use the axial surface for bonding since the shear stress caused by centrifugal force is thereby divided over a large area. This type of bonding may be implemented via adhesives or via any mechanical means that exert an axial force between the plurality of poles and the support plate, such as screws, bolts, nails or rivets.

In one embodiment the fastening means comprises a plurality of axially arranged bolts. Axial bolts are a simple way of tightening the plurality of poles and the support plate together.

In one embodiment each rotor module comprises two support plates provided on axially opposite sides of the plurality of poles. The rotor modules according to this embodiment are self-sustaining and easy to handle without the need of support from an adjacent module.

In one embodiment the support plates comprise first holes which receive the plurality of bolts, and second holes which receive end portions of the plurality of bolts of an adjacent rotor module. By such provision, the rotor modules can be mounted up against one another.

In one embodiment the first holes are aligned with spaces between the magnetic segments. By such provision, the bolts do not traverse through the magnetic segments and do not deteriorate their magnetic properties.

In one embodiment the first holes are aligned with the magnetic segments, and the bolts comprise magnetic material which is electrically isolated from the support plates. By such provision, the negative influence of a bolt traversing through the magnetic segments is minimized.

In one embodiment at least one of the axially arranged bolts exerts an axial force on a plurality of rotor modules. By using one long bolt to fasten several rotor modules, a simplified construction with fewer parts is achieved.

In one embodiment the fastening means comprises an adhesive. An adhesive provides a strong resistance to the shear stress caused by centrifugal force.

In one embodiment the support plate is cast or molded directly into a bonded contact with the plurality of poles, and the fastening means comprises the adhesive force between the support plate material and the pole material. By such provision, no particular fastening means are needed. The support plate material has to be chosen appropriately such that it is suitable for casting.

In one embodiment each of the support plates comprises at least one hole for receiving a cooling fluid. A proper cooling of the rotor is ensured by allowing an axial flow of the cooling fluid through the rotor.

In one embodiment the rotor further comprises a rotor shaft, the rotor modules being fastened in relation to the rotor shaft with a radial fastening means comprising a bolt extending in radial direction. By such provision, the rotor structure is further strengthened.

In one embodiment the support plates comprise non-magnetic material. The magnetic field does not reach high intensity inside the support plates when non-magnetic material is used, the power factor of the machine being thereby increased.

In one embodiment the magnetic segments are made of grain oriented magnetic material having a selected direction of highest magnetic permeability. By using grain oriented material the saliency ratio of the rotor and again the power factor of the machine is increased.

In one embodiment the rotor modules are skewed in relation to each other. Torque ripple of the machine can be reduced by skewing the rotor modules.

In one embodiment the plurality of rotor modules is bonded to one another. By such provision, the rotor structure is further strengthened and the rotor does eventually not need any rotor shaft traversing through the rotor modules.

In one embodiment the rotor is comprised in a synchronous reluctance machine or a switched reluctance machine. The rotor according to the present invention is directly applicable for these two reluctance machine types.

According to a second aspect of the invention a method of manufacturing a rotor for a synchronous reluctance machine is provided. According to the method a plurality of rotor modules is provided, wherein each of the rotor modules is manufactured according to the following. Magnetic segments are provided, a plurality of magnetic segments are spaced apart from one another in radial direction to form poles, a plurality of poles is disposed in adjacent sectors of a circle, a support plate is provided on at least one axial side of the plurality of poles, and the plurality of poles is fastened to the support plate with a fastening means which bonds the plurality of poles to the support plate. Finally, the rotor is formed by disposing the plurality of rotor modules in an axial sequence along a common axis.

Further characteristics of the invention, and advantages thereof, will be evident from the following detailed description of preferred embodiments of the present invention given hereinafter, and the accompanying FIGS. 1-5 which are given by way of illustration only, and are thus not limitative of the present invention.

### BRIEF DESCRIPTION OF THE DRAWINGS

The invention will be explained in greater detail with reference to the accompanying drawings, wherein

FIG. 1 displays schematically, in an exploded view, a rotor module according to one embodiment of the invention;

FIG. 2 displays schematically, in a perspective view, the modular structure of a rotor according to one embodiment of the invention; and

FIG. 3 displays schematically, in a cross-sectional view, a portion of a rotor according to a further embodiment of the invention comprising a radial fastening means.

### DETAILED DESCRIPTION OF THE INVENTION

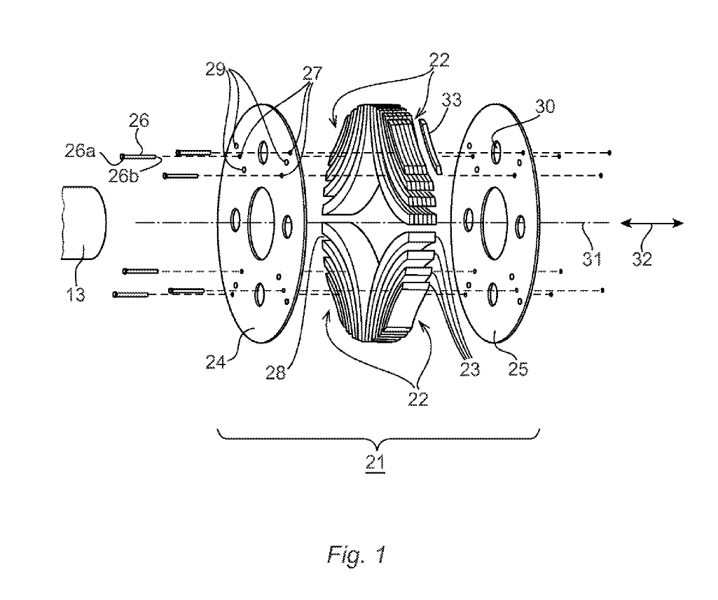

The rotor 12 is, in accordance with the present invention, formed by a plurality of rotor modules 21, of which one is schematically displayed in an exploded view in FIG. 1. The rotor modules 21 comprise a plurality of poles 22 disposed in adjacent sectors about a common axis 31, each pole 22 comprising a plurality of magnetic segments 23 spaced apart from one another in radial direction. The magnetic segments 23 preferably comprise a plurality of laminates 33 stacked in an axial 32 or radial direction.

The rotor modules 21 further comprise a support plate 24, 25 to which the plurality of poles 22 is bonded. The bonding is implemented e.g. via adhesives, welding or fasteners. The same bonding means may be used to bond the laminates 33 to one another.

According to the embodiment of FIG. 1, two support plates 24, 25 preferably of a non-magnetic material are provided on axially opposite sides of the poles 22. The support plates 24, 25 may be of austenitic steel but are preferably made of a material characterized by high electric resistivity such as e.g. ceramic, polymer, or a composite material such as glass fiber or carbon fiber. Each of the support plates 24, 25 comprises first holes 27, second holes 29, and third holes 30.

A plurality of axially arranged bolts 26, received by the first holes 27 of the support plates 24, 25, fasten the two support plates 24, 25 to the poles 22, thereby creating a manageable and robust rotor module 21. The first holes 27 may be aligned with the magnetic segments 23 or with the spaces 28 between the magnetic segments 23. When the first holes 27 are aligned with the magnetic segments 23, the bolts 26 preferably comprise magnetic material which is electrically isolated from the support plates 24, 25, and when the first holes 27 are aligned with the spaces 28 between the magnetic segments 23, the bolts 26 are preferably also of a non-magnetic and electrically non-conducting material.

The second holes 29 are provided to receive or house end portions 26a, 26b of the bolts 26 of an adjacent rotor module 21. For this reason, the second holes 29 are larger than the first holes 27. Every other rotor module 21 comprises support plates 24, 25 as the ones shown in FIG. 1, while every other rotor module 21 comprises support plates which differ from those shown in FIG. 1 in that the locations of the first holes 27 and the second holes 29 are interchanged. Obviously, the two outermost support plates 24, 25 of the rotor 12 do not need to have any second holes 29.

If the rotor modules 21 are not mounted up against one another or are mounted by other fastening means than bolts 26, the support plates 24, 25 of the rotor modules 21 may not need to have any second holes 29. An example of such arrangement is when the plurality of poles 22 is fastened to the support plate 24, 25 with an adhesive.

Another example where second holes 29 are not needed is when a plurality of rotor modules 21 is fastened together with one set of long bolts traversing through the plurality of rotor modules 21. In such an embodiment it is not even necessary to have each rotor module 21 comprising two support plates 24, 25. It suffices with one support plate 24, 25 per rotor module 21, each support plate 24, 25 being fastened to the pole 22 of an adjacent rotor module 21. It is obvious that an extra support plate 24, 25 is needed for the outermost of such set of rotor modules 21.

Yet another example where second holes 29 are not needed is when the support plates 24, 25 are provided with recesses around the first holes 27, the recesses being configured to enclose the end portions 26a, 26b of the bolts 26.

Further, the support plates 24, 25 of the rotor modules 21 may comprise or be provided with ribs, pins, recesses, or similar which secure the positions of the magnetic segments 23 radially and circumferentially.

The third holes 30 of the support plates 24, 25 are provided for receiving a cooling fluid.

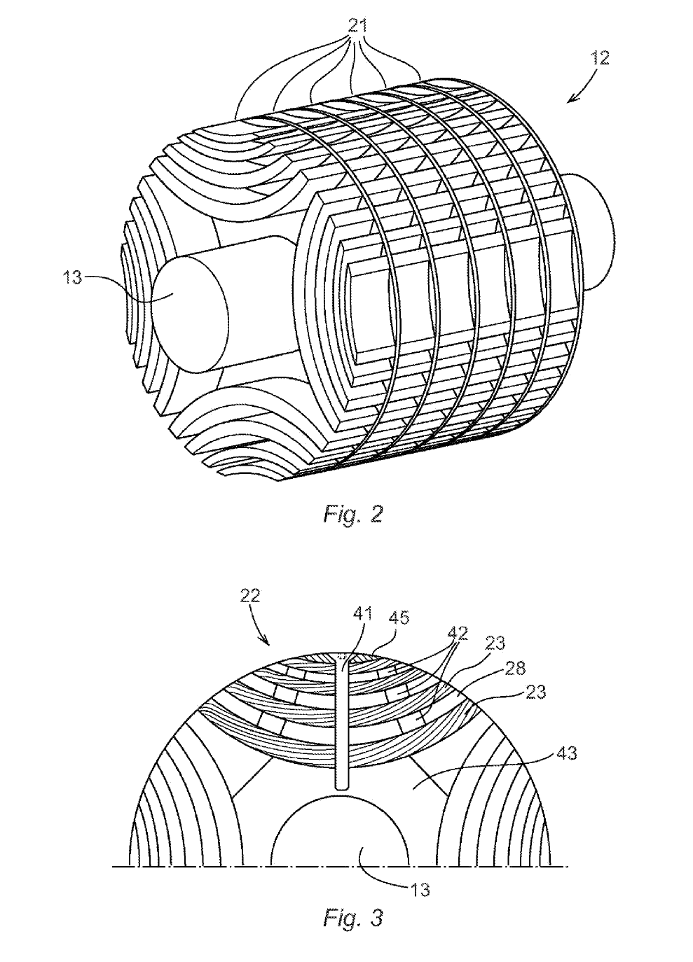

According to FIG. 2, a plurality of rotor modules 21 is mounted up against one another axially to form a rotor 12. The rotor modules 21 are secured to the rotor shaft 13 by means of a tight fitting between each of the rotor modules 21 and the rotor shaft 13. The rotor modules 21 may further be secured to one another in the axial direction 32, e.g. by means of axial bolts (not illustrated). The presence of a rotor shaft 13 is not strictly necessary since the rotor modules 21 can be disposed adjacent and fastened to each other. Such an arrangement can already suffice to build a self-sustaining rotor structure.

The rotor structure may be further strengthened by fastening the rotor modules 21 in relation to the rotor shaft 13 by means of an axial bar 45 and radial bolts 41 according to FIG. 3. The axial bar 45 is arranged on top of the radial outermost magnetic segments 23 and may extend over the whole axial length of the rotor 12. The radial bolts 41 are arranged between rotor modules 21 to fasten the axial bar 45 to the rotor shaft 13.

Further, the embodiment of FIG. 3 comprises distance pieces 42 arranged between the magnetic segments 23 to further secure the positions of the magnetic segments 23 in radial and circumferential direction. The magnetic barriers 42 are preferably of a non-magnetic and electrically non-conducting material such as e.g. a composite, ceramic, or polymer material.

Still further, the rotor 12 of FIG. 3 comprises a core 43 fixedly attached to the rotor shaft 13. The core 43 comprises supports 44 which are configured, dimensioned, and positioned to support the poles 22 of the rotor. Such supports are further described in U.S. Pat. No. 6,064,134, the contents of which being hereby incorporated by reference.

In other respects, the embodiment of FIG. 3 is similar to that of FIGS. 1-2.

In a still further embodiment of the invention each of the laminates 33 is made of grain oriented magnetic material having a selected direction of highest magnetic permeability. The direction of highest magnetic permeability preferably follows as far as possible the longitudinal curved shape of each laminate 33. Although the magnetic segments 23 of FIG. 1 consist of laminates 33 stacked in axial direction 32, the laminates 33 may also be stacked in radial direction in order to take greater advantage of the grain oriented characteristic of the material. A rotor comprising laminates of grain oriented magnetic material is disclosed in U.S. Pat. No. 6,066,904, the contents of which being hereby incorporated by reference. This rotor, however, consists of transversally stacked laminate disks, and therefore the number of poles being used is limited to two.

Further, in order to reduce the torque ripple, the rotor 12 of the present invention may comprise axially skewed rotor modules 21. Axially skewed laminate disks are being disclosed in US 2008/0296994, the contents of which being hereby incorporated by reference. Rotor modules 21 are axially skewed when the poles 22 of two adjacent rotor modules 21 are angled about the common axis 31.

The present invention covers also a method of manufacturing the above described rotor, in which a plurality of rotor modules 21 is manufactured in a first step. This may be made in a pre-manufacturing stage followed by intermediate storing. The rotor modules 21 can be used in synchronous reluctance machines or switched reluctance machines of different power ratings.

Each rotor module 21 is manufactured according to the following. A plurality of magnetic segments 23 is provided. Poles 22 are formed by spacing a plurality of magnetic segments 23 apart from one another in radial direction. A plurality of poles 22 is disposed in adjacent sectors of a circle. A support plate 24, 25 is arranged on at least one axial side of the plurality of poles 22. The plurality of poles 22 is fastened to the support plate 24, 25 with fastening means which bonds the plurality of poles 22 to the support plate 24, 25.

In a second step the rotor 12 is formed by disposing the plurality of rotor modules 21 in an axial sequence along a common axis 31.

The invention is not limited to the embodiments shown above, but the person skilled in the art may, of course, modify them in a plurality of ways within the scope of the invention as defined by the claims. For example, whereas the support plates 24, 25 of the illustrated embodiments are disk shaped, according to the invention they can be of any suitable shape such as a cross, a square or a star.

1. A rotor for a synchronous reluctance machine, the rotor comprising a plurality of rotor modules disposed in an axial sequence along a common axis, each rotor module comprising:
a plurality of poles disposed in adjacent sectors about the common axis, each pole comprising a plurality of magnetic segments spaced apart from one another in radial direction; and
a fastening means bonding the plurality of poles to the support plate,
characterized in that
each rotor module comprises two support plates provided on axially opposite sides of the plurality of poles.

2. The rotor of claim 1, wherein the fastening means bonds the axial surface of the plurality of poles to the support plate.

3. The rotor of claim 2, wherein the fastening means comprises a plurality of axially arranged bolts.

4. The rotor of claim 3, wherein the support plates comprise first holes which receive the plurality of bolts, and second holes which receive end portions of the plurality of bolts of an adjacent rotor module.

5. The rotor of claim 4, wherein the first holes are aligned with spaces between the magnetic segments.

6. The rotor of claim 5, wherein the first holes are aligned with the magnetic segments, and the bolts comprise magnetic material which is electrically isolated from the support plates.

7. The rotor of claim 3, wherein at least one of the axially arranged bolts exerts an axial force on a plurality of rotor modules.

8. The rotor of claim 2, wherein the fastening means comprises an adhesive.

9. The rotor of claim 2, wherein the support plate is cast or molded directly into a bonded contact with the plurality of poles, and the fastening means comprises the adhesive force between the support plate material and the pole material.

10. The rotor of claim 1, wherein each of the support plates comprises at least one hole for receiving a cooling fluid.

11. The rotor of claim 1, wherein the rotor further comprises a rotor shaft, the rotor modules being fastened in relation to the rotor shaft with a radial fastening means comprising a bolt extending in radial direction.

12. The rotor of claim 1, wherein the support plates comprise non-magnetic material.

13. The rotor of claim 1, wherein the magnetic segments are made of grain oriented magnetic material having a selected direction of highest magnetic permeability.

14. The rotor of claim 1, wherein the rotor modules are skewed in relation to each other.

15. The rotor of claim 1, wherein the plurality of rotor modules is bonded to one another.

16. A reluctance machine comprising a rotor comprising a plurality of rotor modules disposed in an axial sequence along a common axis, wherein the reluctance machine is a synchronous reluctance machine or a switched reluctance machine.
